(19) United States
(12) Patent Application Publication
(10) Pub. No.: US 2014/0355125 A1
(43) Pub. Date: Dec. 4, 2014

(54) OPTICAL FILM STACK

(71) Applicant: 3M INNOVATIVE PROPERTIES COMPANY, Saint Paul, MN (US)

(72) Inventors: Gary T. Boyd, Woodbury, MN (US); Qingbing Wang, Woodbury, MN (US); Tri D. Pham, Woodbury, MN (US)

(21) Appl. No.: 14/367,125

(22) PCT Filed: Dec. 18, 2012
(86) PCT No.: PCT/US2012/070375

§ 371 Date: Jun. 19, 2014

Related U.S. Application Data
(60) Provisional application No. 61/578,318, filed on Dec. 21, 2011.

(51) Int. Cl. G02B 5/02

(52) U.S. Cl. CPC G02B 5/02
USPC 359/599

(57) ABSTRACT

Example light management films are described. In one example, an optical stack comprises a first light directing film comprising a structured major surface opposite a second major surface, the structured major surface comprising a plurality of linear structures extending along a first direction, the light directing film having an average effective transmission of at least 1.3; and an asymmetric light diffuser disposed on the light directing film and being more diffusive along a second direction and less diffusive along a third direction orthogonal to the second direction, the second direction making an angle with the first direction that is greater than zero and less than 60 degrees.

### TECHNICAL FIELD

The disclosure relates to display devices and, in particular, films that may be used in backlit display devices.

### BACKGROUND

Optical displays, such as liquid crystal displays (LCDs), are becoming increasingly commonplace, and may be used, for example, in mobile telephones, portable computer devices ranging from hand held personal digital assistants (PDAs) to laptop computers, portable digital music players, LCD desktop computer monitors, and LCD televisions. In addition to becoming more prevalent, LCDs are becoming thinner as the manufacturers of electronic devices incorporating LCDs strive for smaller package sizes. Many LCDs use a backlight for illuminating the LCD's display area.

### SUMMARY

In general, the disclosure relates to an optical film stack that may be used, for example, in a backlit display device. The optical stack may include a light directing film with a structured major surface including a plurality of linear structure extending along a first direction. The optical stack may also include an asymmetric light diffuser disposed on the light directing film. The asymmetric light diffuser may be more diffusive along a second direction while less diffusive along a third direction orthogonal to the second direction. The asymmetric light diffuser may be disposed relative to the light directing film such that the second direction makes an angle with the first direction that is greater than zero and less than 60 degrees. When employed in a backlit display device, the optical film stack may be disposed between the light guide and display surface with the light directing film between the light guide and asymmetric light diffuser. In some examples, the optical film stack may be configured to substantially eliminate visual defects, such as, e.g., moiré patterns resulting from interference between linear structures and possibly their reflections, or color non-uniformities resulting from prism dispersion or birefringence effects, which may be associated with in some cases with light directing films, in a display device while additionally minimizing sparkle, i.e., graininess that depends on viewing angle of a display device.

In one example, the disclosure is directed to an optical stack comprising a first light directing film comprising a structured major surface opposite a second major surface, the structured major surface comprising a plurality of linear structures extending along a first direction, the light directing film having an average effective transmission of at least 1.3; and an asymmetric light diffuser disposed on the light directing film and being more diffusive along a second direction and less diffusive along a third direction orthogonal to the second direction, the second direction making an angle with the first direction that is greater than zero and less than 60 degrees.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual diagram illustrating an example backlit display device.

FIG. 2 is a conceptual diagram illustrating an example optical film stack.

FIG. 3 is a conceptual diagram illustrating another example optical film stack.

FIG. 4 is a photograph of an example asymmetric light diffuser.

FIG. 5 is a conceptual diagram illustrating an example optical system for measuring effective transmission.

FIG. 6 is a conceptual diagram illustrating an example asymmetric light diffuser.

FIGS. 7A and 7B are schematic side-views of example matte layers.

FIGS. 8A and 8B are schematic top-views of example microstructures of an example asymmetric light diffuser.

FIG. 9 is a schematic side view of an example matte layer.

FIG. 10 is a schematic side-view of an example asymmetric light diffuser.

FIG. 11 is a schematic side-view of another example asymmetric light diffuser.

FIG. 12 is a schematic side-view of an example cutting tool system.

### DETAILED DESCRIPTION

In general, the disclosure relates to an optical film stack that may be used, for example, in a backlit display device. The optical stack may include a light directing film with a structured major surface including a plurality of linear structure extending along a first direction. The optical stack may also include an asymmetric light diffuser disposed on the light directing film. The asymmetric light diffuser may be more diffusive along a second direction while less diffusive along a third direction orthogonal to the second direction. The asymmetric light diffuser may be disposed relative to the light directing film such that the second direction makes an angle with the first direction that is greater than zero and less than 60 degrees.

In some examples, a backlit display device may include of a light source, a lightguide, a Liquid Chrystal Display (LCD), and an optical film stack between the lightguide and LCD. In such examples, light originating from the backlight may be used to illuminate the LCD after traveling through the lightguide, and optical film stack. More specifically, light exiting a lightguide may travel through the optical film stack before entering the LCD.

In some examples, a display device may include a rear reflector layer separated from the stack of light management films by the lightguide. The combination of the optical stack, lightguide, and reflective layers may be referred to as a backlight stack. For instances in which the layers of the backlight stack are oriented substantially parallel to the display surface of the LCD and the light source is adjacent to one or more edges, the backlight stack may include the rear reflector, lightguide, one or more light directing films and light diffuser in that order from back to front. In some examples, the light directing film can consist of a clear substrate topped with a plurality of parallel linear prisms with 90 degree apex angles. In cases in which the backlight stack includes two light directing layers, the prisms of the rear most prism film may be oriented to generally run in a direction orthogonal to those of the front prism film. In such cases, the prism films may be described as being in a crossed orientation, and may be configured to redirect some of the light from the lightguide toward the LCD.

In some examples, there may be one or more display defects associated with the employment of such light directing films. For example, in some cases, the use of one or more light directing films may result in moiré patterns resulting from interference between linear prism structures, or between such structures and their reflections, or both. To address such defects, a light diffusing layer such as a matter layer may be used to spread out the light exiting the light directing layer prior to illuminating a display. However, the use of such light diffusing layer may cause sparkle in the display. As used herein, the term sparkle refers to graininess that depends on viewing angle of a display device.

In accordance with some examples of the disclosure, an optical stack may include a first light directing film and an asymmetric light diffuser disposed relative to the first light directing film in a manner that, for example, substantially eliminates defects, such as, e.g., moiré and color non-uniformities associated with the light directing film, in a display device while additionally minimizing sparkle associated with the use of a diffusive film. For example, the structured surface of the light directing film may include a plurality of linear structures (e.g., prisms) extending along a first direction and the asymmetric light diffuser may be more diffusive along a second direction and less diffusive along a third direction orthogonal to the second direction. In such a case, the light directing film may be disposed relative to the light diffuser such that the second direction makes an angle with the first direction that is greater than zero and less than 60 degrees. As noted above, in some cases, such an optical film has been determined to substantially eliminate defects, such as, e.g., moiré and color non-uniformities associated with the light directing film, in a display device while additionally minimizing sparkle associated with the use of a diffusive film. As will be described further below, in some examples the optical stack may include one or more additional layers besides that of the first light directing film and asymmetric light diffuser.

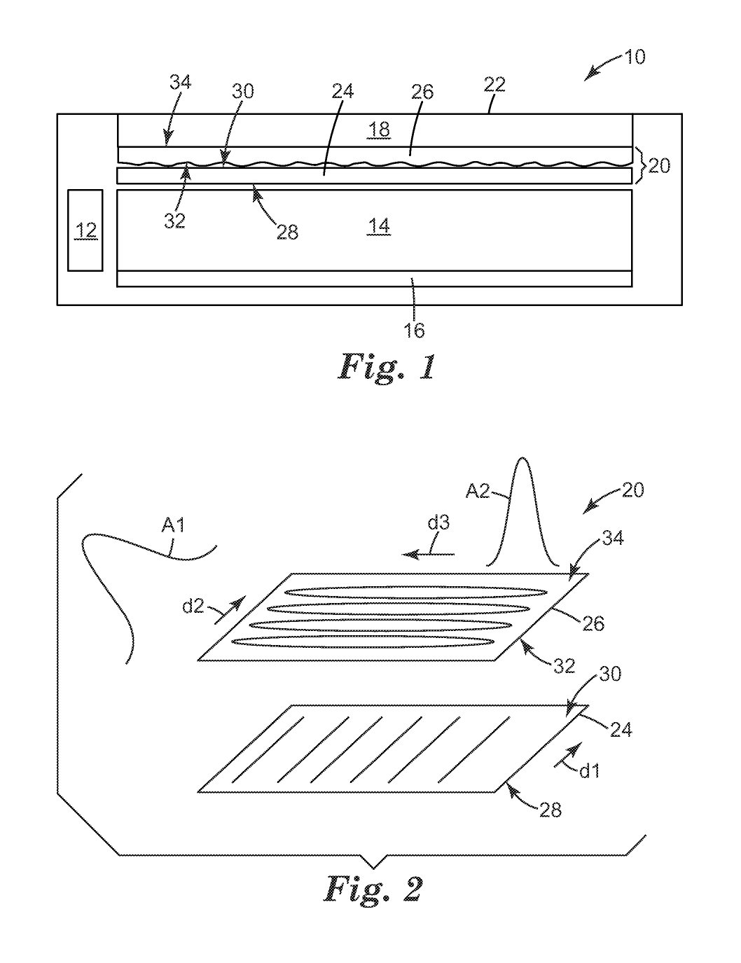

FIG. 1 is a conceptual diagrams illustrating example backlit display device 10. Backlit display device 10 includes light source 12, lightguide 14, reflector 16, LCD 18, and optical stack 20. As shown, optical stack includes light directing film 24 and asymmetric light diffuser 26 disposed on light directing film 24. Although backlit display device 10 is illustrated with a single light source 14 adjacent to one edge of lightguide 14, other configurations are contemplated. For example, backlit display device 10 may include more than one light source 12 adjacent to one or more surfaces of lightguide 14.

Light source 14 may be any suitable type of light source such as a fluorescent lamp or a light emitting diode (LED). Furthermore, light source 14 may include a plurality of discrete light sources such as a plurality of discrete LEDs. To illuminate the outer display surface 22 of LCD 18, light from light source 12 propagates through lightguide 14 in the general z-direction. At least a portion of the light exits through the upper surface of light guide 14 into optical stack 20. Reflector 16 is located below lightguide 14, and reflects light back towards optical stack 20.

Lightguide 14 of backlit display device 10 may be any suitable lightguide known in the art and may include one or more of the example lightguides described in U.S. Pat. No. 6,002,829 to Winston et al. dated Dec. 14, 1999, and U.S. Pat. No. 7,833,621 to Jones et al. dated Nov. 16, 2010. The entire content of each of these U.S. are incorporated by reference herein. Suitable materials for reflector 16 adjacent to lightguide 14 may include Enhanced Specular Reflector (available commercially from 3M, St. Paul, Minn.), or a white PET-based reflector.

Light directing film 24 includes structured major surface 30 opposite that of second major surface 28. Structured major surface 30 (structure not shown in FIG. 1) may include a plurality of linear structures extending along a first direction. A portion of the light entering light directing film 24 from lightguide 14 may be redirected by light directing film 24 before entering asymmetric light diffuser 26, while other portions of light may not be redirected or may be redirected by optical stack 20 back into lightguide 14. Some of this light may be “recycled” in the sense that the light may be reflected by reflector 16 back into lightguide 14. As will be described below, in some examples, light directing film 24 may have an average effective transmission of at least 1.3.

In some examples, second major surface 28 of light directing film 24 may be light diffusive. In some examples, second major surface 28 may also be a structured surface, e.g., defined by a non-uniform coating deposited on a substrate. Although light directing film 24 is shown with the top surface as structured surface 30, in other examples, structured surface 30 may be the bottom surface of light directing film 24 with the top surface being second surface 28.

Optical stack 20 also includes asymmetric light diffuser 26 disposed on light directing film 24. Asymmetric light diffuser 26 includes top major surface 34 and bottom major surface 32 adjacent structured surface 30 of light directing film 24. Light from light directing layer 24 entering asymmetric light diffuser 26 may be diffused or spread out in one or more directions prior to exiting asymmetric diffuser 26 into display 18 to illuminate display surface 22. Asymmetric light diffuser 26 may be referred to as an “asymmetric” light diffuser in the sense that light entering light diffuser 26 is not diffused equally in all directions but instead the light may be diffused more in one direction than another. As will be described below with regard to FIG. 2, asymmetric light diffuser 26 may be configured to be more diffusive in a second direction d2 than a third direction d3. Asymmetric diffuser 26 may be configured to reduce the resolution of undesired visual artifacts due to, e.g., light directing layer 24.

FIG. 2 is a conceptual diagram illustrating an exploded view of optical stack 20 including light directing film 24 and asymmetric light diffuser 26. Structured major surface 30 faces asymmetric diffuser 26 and second major surface 28 faces away from asymmetric diffuser 26. Structured major surface 30 includes a plurality of linear structures, including individually labeled linear structure 31, extending along first direction d1, which may serve to redirect (e.g., toward the axial direction) at least a portion of light entering light directing film 24 towards LCD 18. For ease of description, properties of the plurality of linear structures are described generally with reference to individual linear structure 31 but those properties apply generally to all the plurality of linear structures of structured major surface 30.

In some examples, linear structure 31 may take the form of a prism extending along first direction d1. In such an example, light directing film 24 may be referred to as a prismatic film. The prisms may protrude from the surface of the light directing film 24, and may include two or more faucets that meet at a peak to define a peak angle. In some examples, linear structure 31 may include a prism including facets that define a peak angle in the range from 70 to 120 degrees, such as, e.g., 80 to 110 degrees or 85 to 95 degrees, although other peak angles are contemplated. In some examples, a suitable light directing film may include a Brightness Enhancing Film or “BEF” (commercially available from 3M, St. Paul, Minn.). Although linear structure 31 is described in terms of a prism, other structures are contemplated. In some examples, linear structure 31 may have cylindrical cross sectional profiles or combinations of linear and curved features in the profile. Linear structure 31 exhibit variation in height, tilt and cross section along the direction d1.

As noted above, second surface 28 may be light diffusive. For example, second surface 28 may include a matte coating. In some examples, second surface 28 may be a structured surface. For example, second surface 28 may be defined by a non-uniform coating that provides for a non-uniform surface structure. Also, in some examples, second surface 28 may be nearer asymmetric light diffuser 26 than that of structured major surface 30 (i.e., second surface 28 may face asymmetric light diffuser 26).

When light directing film 24 is used in a liquid crystal display system, the light directing film 24 can increase or improve the axial brightness of the display. In such cases, the light directing film has an effective transmission or relative gain that is greater than 1. As described above, in some examples, light directing film 24 of optical stack 20 may have an average effective transmission of at least 1.3, such as, e.g., at least 1.4, at least 1.5, at least 1.6, or at least 1.7.

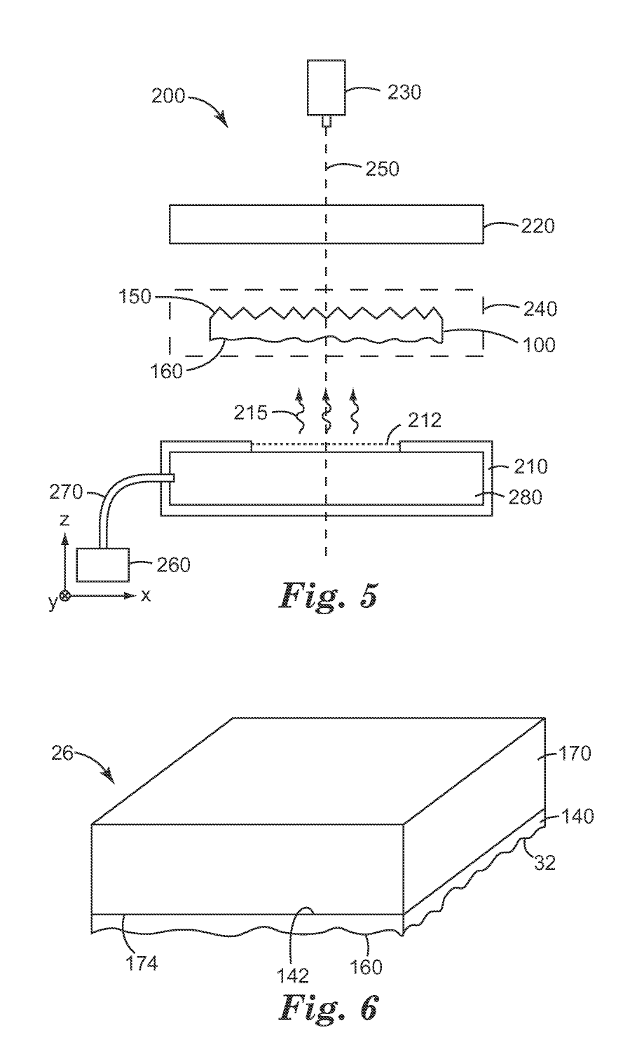

As used herein, effective transmission is the ratio of the axial luminance of the display system with the film in place in the display system to the axial luminance of the display without the film in place. Effective transmission (ET) can be measured using optical system 200, a schematic side-view of which is shown in FIG. 5. Optical system 200 is centered on an optical axis 250 and includes a hollow lambertian light box that emits a lambertian light 215 through an emitting or exit surface 212, a linear light absorbing polarizer 220, and a photo detector 230. Light box 210 is illuminated by a stabilized broadband light source 260 that is connected to an interior 280 of the light box via an optical fiber 270. A test sample, the ET of which is to be measured by the optical system, is placed at location 240 between the light box and the absorbing linear polarizer.

The ET of light directing film 24 can be measured by placing the light directing film in location 240 with linear prisms 150 facing the photo detector and microstructures 160 facing the light box. Next, the spectrally weighted axial luminance I₁ (luminance along optical axis 250) is measured through the linear absorbing polarizer by the photo detector. Next, the light directing film is removed and the spectrally weighted luminance I₂ is measured without the light directing film placed at location 240. ET is the ratio I₁/I₂. ET0 is the effective transmission when linear prisms 150 extend along a direction that is parallel to the polarizing axis of linear absorbing polarizer 220, and ET90 is the effective transmission when linear prisms 150 extend along a direction that is perpendicular to the polarizing axis of the linear absorbing polarizer. The average effective transmission (ETA) is the average of ET0 and ET90.

Any suitable material may be used to form light directing film 24. As described above, the shape and materials of plurality of tapered protrusions 30 may allow at least a portion of light from lightguide 14 passing through light directing layer 26 to reduce the divergence of incident light and redirect a majority of incident light propagating along a first direction to a second direction different from the first direction. Suitable materials may include optical polymers such as acrylates, polycarbonate, polystyrene, styrene acrylo nitrile, and the like. Suitable materials may include those materials used to form Brightness Enhancing Film or “BEF” (commercially available from 3M, St. Paul, Minn.). In some examples, the material used to form light directing film 24 may have a refractive index between approximately 1.4 and approximately 1.7, such as, e.g., between approximately 1.45 and approximately 1.6.

Light directing film 24 may include an overall thickness defined by the substrate thickness and prism height above the surface of the substrate. In some examples, light directing film 24 may have a substrate thickness between about 25 micrometers and about 250 micrometers, and a prism height between about 8 micrometers and about 50 micrometers. In some examples, the overall thickness of light directing film 24 may be between about 30 micrometers and about 300 micrometers. Other thicknesses and heights are contemplated.

As illustrated in FIG. 2, asymmetric light diffuser 26 is disposed on light directing film 24, and includes bottom surface 32 and top surface 34. In general, asymmetric light diffuser 26 may diffuse light more in one direction than another. As illustrated in FIG. 2, asymmetric light diffuser 26 may be more diffusive along second direction d2 than along third direction d3, which is orthogonal to that of second direction d2. For purposes of illustrating the relative diffusiveness of asymmetric light diffuser 26 along the second direction d2 relative to that along the third direction d3, diffusion in the second direction d2 with first viewing angle A1 is shown relative to diffusion in the third direction with a second viewing angle A2. As shown, A2 represents that asymmetric light diffuser 26 may scatter light more along second direction d2 than along third direction d3, e.g., as the width of the curve along direction d2 is greater than the width of the curve along direction d3.

In some examples, asymmetric light diffuser 26 scatters light along the second direction d2 with first viewing angle A₁ and along the third direction d3 with a second viewing angle A₂, with A₁/A₂ being at least 1.5, such as, e.g., at least 2, at least 2.5, at least 3, at least 4, at least 6, at least 8, or at least 10. As used herein, a viewing angle may refer to the angle at which the luminance is one half that of the maximum.

As shown in FIG. 2, first light directing film 24 may be disposed relative to asymmetric light diffuser 26 such that second direction d2 defines an angle with first direction d1. In some examples, first light directing film 24 may be disposed relative to asymmetric light diffuser 26 such that the second direction d2 makes an angle with first direction d1 greater than zero (i.e., d2 and d1 are non-parallel) and less than 60 degrees, such as, e.g., greater than zero and less than 50 degrees or greater than zero and less than 40 degrees. As noted above, it has been determined that some examples of the optical stacks described herein may substantially eliminate defects, such as, e.g., moiré and color non-uniformities associated with light directing film 24, in a display device while additionally minimizing sparkle associated with the use of a diffusive film.

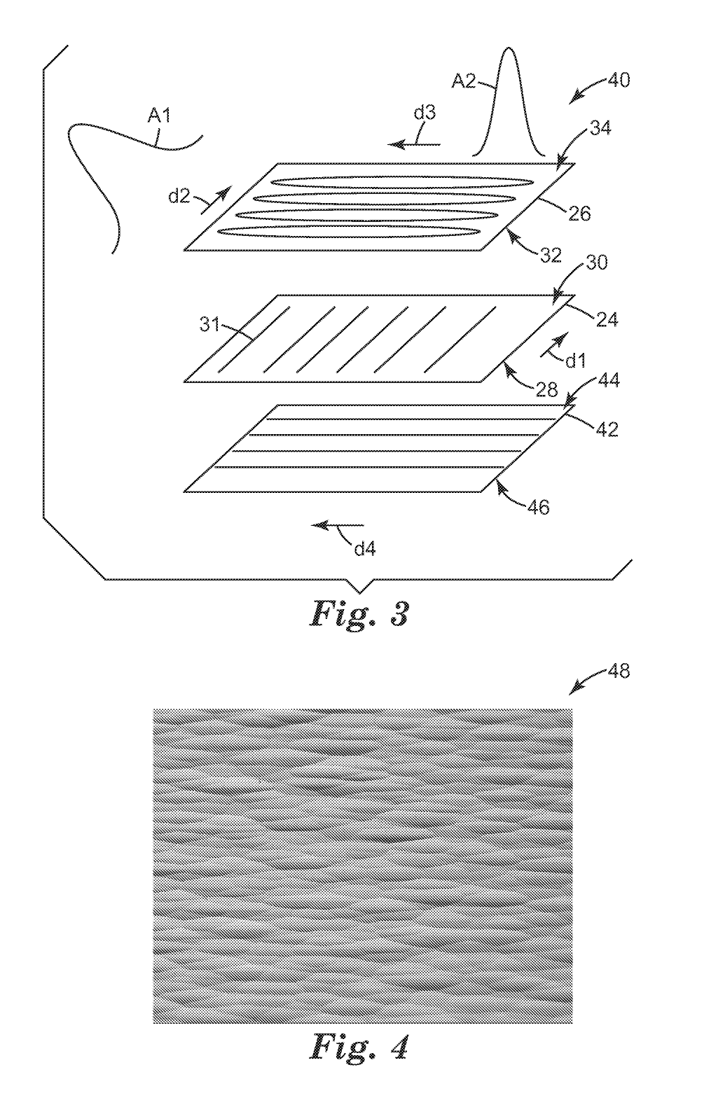

FIG. 3 is a conceptual diagram illustrating an exploded view of another optical film stack 40. Optical film stack 40 includes first light directing film 24 and asymmetric light diffuser 26, and may be substantially the same as optical film stack 20. However, optical film stack 40 includes second light directing film 42 disposed on first light directing film 24. First light directing film 24 separates second light directing film 42 from asymmetrical light diffuser 26. Second light directing film 42 includes second structured surface 44 opposite second major surface 46. Structured major surface 44 faces asymmetric diffuser 26 and second major surface 46 faces away from asymmetric diffuser 26.

Second light directing film 42 may have properties the same or substantially similar to that described herein with regard to first light directing film 24. For example, second light directing film 42 of optical stack 40 may have an average effective transmission of at least 1.3, such as, e.g., at least 1.4, at least 1.5, at least 1.6, or at least 1.7. As another example, second surface 46 may be light diffusive. For example, second surface 46 may include a matte coating. In some examples, second surface 46 may be a structured surface. For example, second surface 46 may be defined by a non-uniform coating that provides for a non-uniform surface structure. Also, in some examples, second surface 46 may be nearer asymmetric light diffuser 26 than that of structured major surface 44 (i.e., second surface 46 may face asymmetric light diffuser 26). In some examples, while it may be possible that a single prism film is inverted as a turning film in such a manner, it may not be the case that such an inverted film is accompanied by another structure film, which is inverted or not inverted.

As another example, similar to that of first light directing film 24, second light directing film 42 includes a plurality of linear structures (e.g., a plurality of linear prisms defining with facets that define a peak angle in the range from 70 to 120 degrees, such as, e.g., 80 to 110 degrees or 85 to 95 degrees). However, as second light directing film 40 is oriented relative to first light directing film 40, the plurality of linear structures of structured surface 44 extend along a fourth direction d4 rather than the first direction d1. In some examples, optical stack 40 may be oriented such that the second direction d2 defines a smaller angle with the first direction d1 than with the fourth direction d4. As shown in FIG. 3, the fourth direction d4 is substantially orthogonal to that of the first direction. In some cases, first and second light directing films 24 and 42 may be referred as being in a crossed orientation.

In either of optical stack 20 or optical stack 40, asymmetric light diffuser 26 may be any suitable asymmetric light diffuser capable of providing the properties described herein. In some examples, asymmetric light diffuser 26 may comprise a volume (or bulk) diffuser. In some examples, a volume diffuser may include a host material with a first refractive index suffused with particles of a second refractive index, where the first and second refractive indices differ by at least 0.01, and where the volume fraction of the particles is at least 0.1%. In such examples, light diffusion is accomplished by repeated reflection and refraction by the particles, which thereby alter the original ray directions. In some examples, asymmetric light diffuser 26 may comprise a surface diffuser comprising a structured major surface. For example, asymmetric light diffuser 26 may comprise a microreplicated matte coating. In some examples, suitable asymmetric light diffuser may include one or more of the examples described in published PCT patent application WO 2010/141261, bearing application no. PCT/US2010/036018, and filed May, 25, 2010, the entire content of which is incorporated herein by reference.

In one example, as shown in FIG. 6, asymmetric light diffuser 26 may include a matte layer 140 deposited on substrate 170. Substrate 170 may include PET, poly carbonate, or other suitable material. Microstructures 160 in matte layer 140 may be designed to hide undesirable physical defects (such as, for example, scratches) and/or optical defects (such as, for example, undesirably bright or “hot” spots from a lamp in a display or illumination system) with no, or very little adverse, effect on the capabilities of the light directing film to redirect light and enhance brightness.

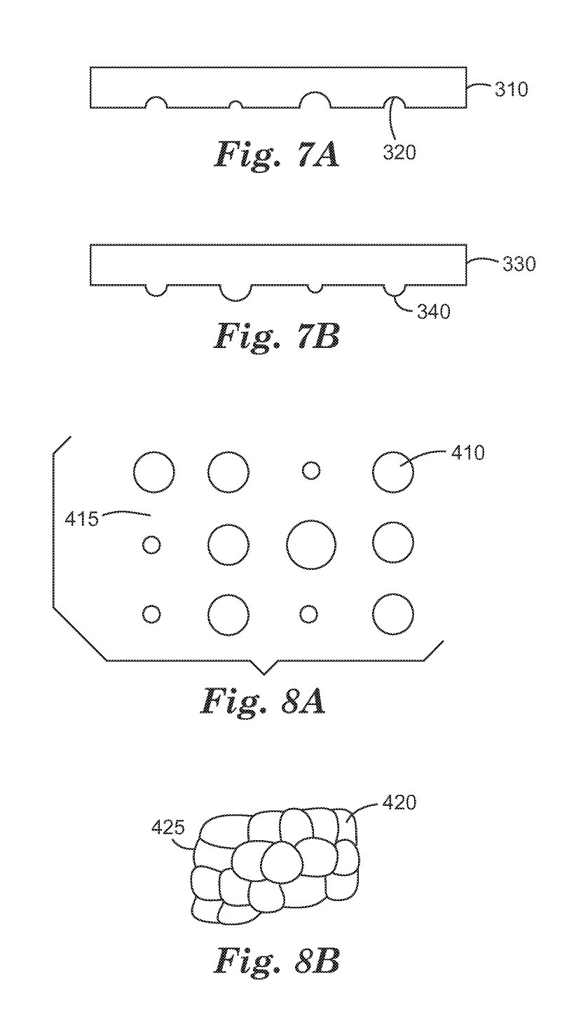

Microstructures 160 can be any type microstructures that may be desirable in an application. In some cases, microstructures 160 can be recessions. For example, FIG. 7A is a schematic side-view of a matte layer 310 that is similar to matte layer 140 and includes recessed microstructures 320. In some cases, microstructures 160 can be protrusions. For example, FIG. 7B is a schematic side-view of a matte layer 330 that is similar to matte layer 140 and includes protruding microstructures 340.

In some cases, microstructures 160 form a regular pattern. For example, FIG. 8A is a schematic top-view of microstructures 410 that are similar to microstructures 160 and form a regular pattern in a major surface 415. In some cases, microstructures 160 form an irregular pattern. For example, FIG. 8B is a schematic top-view of microstructures 420 that are similar to microstructures 160 and form an irregular pattern. In some cases, microstructures 160 form a pseudo-random pattern that appears to be random but has a repeating pattern aspect as evidenced by, for example, the presence of one or peaks in a two-dimensional Fourier spectrum of the surface topography.

In general, microstructures 160 of asymmetric diffuser 26 can have any height and any height distribution. In some cases, the average height (that is, the average peak height minus the average valley height) of microstructures 160 is not greater than about 5 microns, or not greater than about 4 microns, or not greater than about 3 microns, or not greater than about 2 microns, or not greater than about 1 micron, or not greater than about 0.9 microns, or not greater than about 0.8 microns, or not greater than about 0.7 microns.

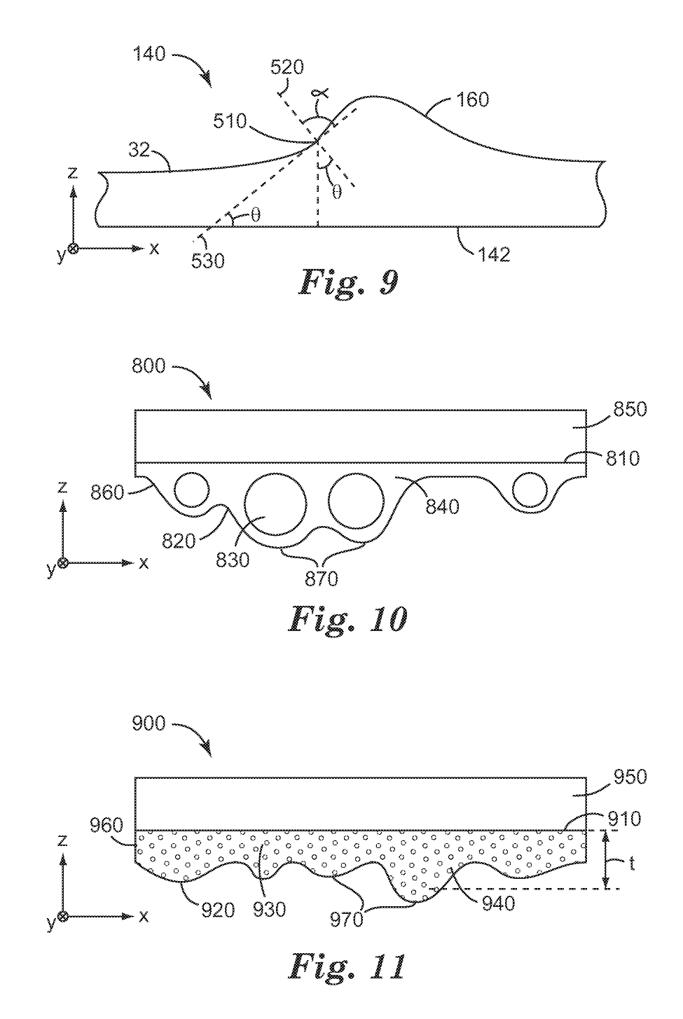

FIG. 9 is a schematic side view of a portion of matte layer 140 of asymmetric diffuser 26. In particular, FIG. 9 shows a microstructure 160 in major surface 32 and facing major surface 142. Microstructure 160 has a slope distribution across the surface of the microstructure. For example, the microstructure has a slope θ at a location 510 where θ is the angle between normal line 520 which is perpendicular to the microstructure surface at location 510 (α=90 degrees) and tangent line 530 which is tangent to the microstructure surface at the same location. Slope θ is also the angle between tangent line 530 and major surface 142 of the matte layer.

FIG. 10 is a schematic side-view of an asymmetric light diffuser 800 that includes a matte layer 860 disposed on a substrate 850 similar to substrate 170. Matte layer 860 includes a first major surface 810 attached to substrate 850, a second major surface 820 opposite the first major surface, and a plurality of particles 830 dispersed in a binder 840. Second major surface 820 includes a plurality of microstructures 870. A substantial portion, such as at least about 50%, or at least about 60%, or at least about 70%, or at least about 80%, or at least about 90%, of microstructures 870 are disposed on and formed primarily because of particles 830. In other words, particles 830 are the primary reason for the formation of microstructures 870. In such cases, particles 830 have an average size that is greater than about 0.25 microns, or greater than about 0.5 microns, or greater than about 0.75 microns, or greater than about 1 micron, or greater than about 1.25 microns, or greater than about 1.5 microns, or greater than about 1.75 microns, or greater than about 2 microns.

In some cases, matte layer 140 can be similar to matte layer 860 and can include a plurality of particles that are the primary reason for the formation of microstructures 160 in second major surface 32.

Particles 830 can be any type particles that may be desirable in an application. For example, particles 830 may be made of polymethyl methacrylate (PMMA), polystyrene (PS), or any other material that may be desirable in an application. In general, the index of refraction of particles 830 is different than the index of refraction of binder 840, although in some cases, they may have the same refractive indices. For example, particles 830 can have an index of refraction of about 1.35, or about 1.48, or about 1.49, or about 1.50, and binder 840 can have an index of refraction of about 1.48, or about 1.49, or about 1.50.

In some cases, matte layer 140 does not include particles. In some cases, matte layer 140 includes particles, but the particles are not the primary reason for the formation of microstructures 160. For example, FIG. 11 is a schematic side-view of an asymmetric light diffuser 900 that includes a matte layer 960 similar to matter layer 140 disposed on a substrate 950 similar to substrate 170. Matte layer 960 includes a first major surface 910 attached to substrate 950, a second major surface 920 opposite the first major surface, and a plurality of particles 930 dispersed in a binder 940. Second major surface 970 includes a plurality of microstructures 970. Even though matte layer 960 includes particles 930, the particles are not the primary reason for the formation of microstructures 970. For example, in some cases, the particles are much smaller than the average size of the microstructures. In such cases, the microstructures can be formed by, for example, microreplicating a structured tool. In such cases, the average size of particles 930 is less than about 0.5 microns, or less than about 0.4 microns, or less than about 0.3 microns, or less than about 0.2 microns, or less than about 0.1 microns. In such cases, a substantial fraction, such as at least about 50%, or at least about 60%, or at least about 70%, or at least about 80%, or at least about 90%, of microstructures 970 are not disposed on particles that have an average size that is greater than about 0.5 microns, or greater than about 0.75 microns, or greater than about 1 micron, or greater than about 1.25 microns, or greater than about 1.5 microns, or greater than about 1.75 microns, or greater than about 2 microns. In some cases, the average size of particles 930 is less than the average size of microstructures 930 by at least a factor of about 2, or at least a factor of about 3, or at least a factor of about 4, or at least a factor of about 5, or at least a factor of about 6, or at least a factor of about 7, or at least a factor of about 8, or at least a factor of about 9, or at least a factor of about 10. In some cases, if matte layer 960 includes particles 930, then matte layer 960 has an average thickness “t” that is greater than the average size of the particles by at least about 0.5 microns, or at least about 1 micron, or at least about 1.5 microns, or at least about 2 microns, or at least about 2.5 microns, or at least about 3 microns. In some cases, if the matte layer includes a plurality of particles then the average thickness of the matte layer is greater than the average thickness of the particles by at least a factor of about 2, or at least a factor of about 3, or at least a factor of about 4, or at least a factor of about 5, or at least a factor of about 6, or at least a factor of about 7, or at least a factor of about 8, or at least a factor of about 9, or at least a factor of about 10.

Asymmetric diffuser layer 26 can be made using any fabrication method that may be desirable in an application. For example, in cases in which asymmetric diffuser layer 26 is formed via microreplication from a tool, the tool may be fabricated using any available fabrication method, such as by using engraving or diamond turning. Exemplary diamond turning systems and methods can include and utilize a fast tool servo (FTS) as described in, for example, PCT Published Application No. WO 00/48037, and U.S. Pat. Nos. 7,350,442 and 7,328,638, the disclosures of which are incorporated in their entireties herein by reference thereto. Other suitable techniques for forming asymmetric diffuser 26 are also contemplated.

FIG. 4 is a photograph of an example asymmetric light diffuser 48 that may be employed in one or more of the optical stacks described herein. As described above, asymmetric light diffuser 48 may include a plurality of elongated structures (not labeled in FIG. 4). In some examples, the average length, width, and height of such elongated structures may be such that the structures taper from end to end along the elongation direction, and bulge in the center. In some examples, such structures diffuse light more in the direction perpendicular to the elongation than along the elongation direction.

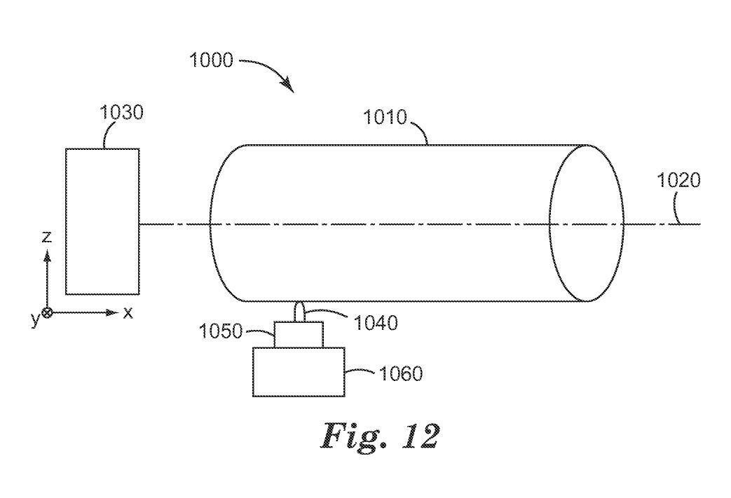

FIG. 12 is a schematic side-view of a cutting tool system 1000 that can be used to cut a tool which can be microreplicated to produce microstructures 160 and matte layer 140 of asymmetric diffuser 26. Cutting tool system 1000 employs a thread cut lathe turning process and includes a roll 1010 that can rotate around and/or move along a central axis 1020 by a driver 1030, and a cutter 1040 for cutting the roll material. The cutter is mounted on a servo 1050 and can be moved into and/or along the roll along the x-direction by a driver 1060. In general, cutter 1040 is mounted normal to the roll and central axis 1020 and is driven into the engraveable material of roll 1010 while the roll is rotating around the central axis. The cutter is then driven parallel to the central axis to produce a thread cut. Cutter 1040 can be simultaneously actuated at high frequencies and low displacements to produce features in the roll that when microreplicated result in microstructures 160.

Servo 1050 is a fast tool servo (FTS) and includes a solid state piezoelectric (PZT) device, often referred to as a PZT stack, which rapidly adjusts the position of cutter 1040. FTS 1050 allows for highly precise and high speed movement of cutter 1040 in the x-, y- and/or z-directions, or in an off-axis direction. Servo 1050 can be any high quality displacement servo capable of producing controlled movement with respect to a rest position. In some cases, servo 1050 can reliably and repeatably provide displacements in a range from 0 to about 20 microns with about 0.1 micron or better resolution.

Driver 1060 can move cutter 1040 along the x-direction parallel to central axis 1020. In some cases, the displacement resolution of driver 1060 is better than about 0.1 microns, or better than about 0.01 microns. Rotary movements produced by driver 1030 are synchronized with translational movements produced by driver 1060 to accurately control the resulting shapes of microstructures 160.

The engraveable material of roll 1010 can be any material that is capable of being engraved by cutter 1040. Exemplary roll materials include metals such as copper, various polymers, and various glass materials.

Cutter 1040 can be any type of cutter and can have any shape that may be desirable in an application. For example, cutter 1040 may define an arc-shape cutting tip. As another example, cutter 1040 may define a V-shape cutting tip 1125. As yet other examples, cutter 1040 may have a piece-wise linear cutting tip or a curved cutting tip.

Various embodiments of the invention have been described. These and other embodiments are within the scope of the following claims.

Exemplary embodiments include the following:

Item 1. An optical stack comprising:
a first light directing film comprising a structured major surface opposite a second major surface, the structured major surface comprising a plurality of linear structures extending along a first direction, the light directing film having an average effective transmission of at least 1.3; and
an asymmetric light diffuser disposed on the light directing film and being more diffusive along a second direction and less diffusive along a third direction orthogonal to the second direction, the second direction making an angle with the first direction that is greater than zero and less than 60 degrees.

Item 2. The optical stack of item 1, wherein the second major surface of the first light directing film is light diffusive.

Item 3. The optical stack of item 1, wherein the second major surface of the first light directing film is structured.

Item 4. The optical stack of claim 1, wherein the plurality of linear structures comprises a plurality of linear prismatic structures extending along the first direction.

Item 5. The optical stack of item 1, wherein each linear prismatic structure has a peak and a peak angle, the peak angle being in a range from 70 to 120 degrees.

Item 6. The optical stack of item 1, wherein each linear prismatic structure has a peak and a peak angle, the peak angle being in a range from 80 to 110 degrees.

Item 7. The optical stack of item 1, wherein each linear prismatic structure has a peak and a peak angle, the peak angle being in a range from 85 to 95 degrees.

Item 8. The optical stack of item 1, wherein the light directing film has an average effective transmission of at least 1.4.

Item 9. The optical stack of item 1, wherein the light directing film has an average effective transmission of at least 1.5.

Item 10. The optical stack of item 1, wherein the light directing film has an average effective transmission of at least 1.6.

Item 11. The optical stack of item 1, wherein the light directing film has an average effective transmission of at least 1.7.

Item 12. The optical stack of item 1, wherein the structured major surface of the first light directing film faces the asymmetric light diffuser and the second major surface of the first light directing film faces away from the asymmetric light diffuser.

Item 13. The optical stack of item 1, wherein the asymmetric light diffuser scatters light along the second direction with a first viewing angle A₁ and along the third direction with a second viewing angle A₂, A₁/A₂ being at least 1.5.

Item 14. The optical stack of item 1, wherein the asymmetric light diffuser scatters light along the second direction with a first viewing angle A₁ and along the third direction with a second viewing angle A₂, A₁/A₂ being at least 2.

Item 15. The optical stack of item 1, wherein the asymmetric light diffuser scatters light along the second direction with a first viewing angle A₁ and along the third direction with a second viewing angle A₂, A₁/A₂ being at least 2.5.

Item 16. The optical stack of item 1, wherein the asymmetric light diffuser scatters light along the second direction with a first viewing angle A₁ and along the third direction with a second viewing angle A₂, A₁/A₂ being at least 3.

Item 17. The optical stack of item 1, wherein the asymmetric light diffuser scatters light along the second direction with a first viewing angle A₁ and along the third direction with a second viewing angle A₂, A₁/A₂ being at least 4.

Item 18. The optical stack of item 1, wherein the asymmetric light diffuser scatters light along the second direction with a first viewing angle A₁ and along the third direction with a second viewing angle A₂, A₁/A₂ being at least 6.

Item 19. The optical stack of item 1, wherein the asymmetric light diffuser scatters light along the second direction with a first viewing angle A₁ and along the third direction with a second viewing angle A₂, A₁/A₂ being at least 8.

Item 20. The optical stack of item 1, wherein the asymmetric light diffuser scatters light along the second direction with a first viewing angle A₁ and along the third direction with a second viewing angle A₂, A₁/A₂ being at least 10.

Item 21. The optical stack of item 1, wherein the asymmetric light diffuser comprises a volume diffuser.

Item 22. The optical stack of item 1, wherein the asymmetric light diffuser comprises a surface diffuser comprising a structured major surface.

Item 23. The optical stack of item 1, wherein the second direction makes an angle with the first direction that is greater than 0 and less than 50 degrees.

Item 24. The optical stack of item 1, wherein the second direction makes an angle with the first direction that is greater than 0 and less than 40 degrees.

Item 25. The optical stack of item 1, wherein the first light directing film is disposed between the asymmetric light diffuser and a second light directing film comprising a structured major surface opposite a second major surface, the structured major surface of the second light directing film comprising a plurality of linear structures extending along a fourth direction orthogonal to the first direction, the light directing film having an average effective transmission of at least 1.3.

Item 26. The optical stack of item 25, wherein the light directing film has an average effective transmission of at least 1.4.

Item 27. The optical stack of item 25, wherein the light directing film has an average effective transmission of at least 1.5.

Item 28. The optical stack of item 25, wherein the light directing film has an average effective transmission of at least 1.6.

Item 29. The optical stack of item 25, wherein the second major surface of the second light directing film is light diffusive.

Item 30. The optical stack of item 25, wherein the second major surface of the second light directing film is structured.

Item 31. The optical stack of item 25, wherein the second direction make a smaller angle with the first direction than with the fourth direction.

1. An optical stack comprising:
a first light directing film comprising a structured major surface opposite a second major surface, the structured major surface comprising a plurality of linear structures extending along a first direction, the light directing film having an average effective transmission of at least 1.3; and
an asymmetric light diffuser disposed on the light directing film and being more diffusive along a second direction and less diffusive along a third direction orthogonal to the second direction, the second direction making an angle with the first direction that is greater than zero and less than 60 degrees.

2. The optical stack of claim 1, wherein the second major surface of the first light directing film is light diffusive.

3. The optical stack of claim 1, wherein the second major surface of the first light directing film is structured.

4. The optical stack of claim 1, wherein the light directing film has an average effective transmission of at least 1.4.

5. The optical stack of claim 1, wherein the asymmetric light diffuser scatters light along the second direction with a first viewing angle A₁ and along the third direction with a second viewing angle A₂, A₁/A₂ being at least 1.5.

6. The optical stack of claim 1, wherein the asymmetric light diffuser comprises a volume diffuser.

7. The optical stack of claim 1, wherein the asymmetric light diffuser comprises a surface diffuser comprising a structured major surface.

8. The optical stack of claim 1, wherein the second direction makes an angle with the first direction that is greater than 0 and less than 50 degrees.

9. The optical stack of claim 1, wherein the first light directing film is disposed between the asymmetric light diffuser and a second light directing film comprising a structured major surface opposite a second major surface, the structured major surface of the second light directing film comprising a plurality of linear structures extending along a fourth direction orthogonal to the first direction, the light directing film having an average effective transmission of at least 1.3.

10. The optical stack of claim 9, wherein the second direction make a smaller angle with the first direction than with the fourth direction.
